(19) United States
(12) Patent Application Publication
(10) Pub. No.: US 2003/0226272 A1
(43) Pub. Date: Dec. 11, 2003

(54) Precision invert measuring tool

(76) Inventor: Elwood S. Finefield, Leehigh Acres, FL (US)

Correspondence Address: Elwood S. Finefield, 202 Ivan Ave N., Leehigh Acres, FL, 33971, US

(21) Appl. No.: 10/165,325

(22) Filed: Jun. 10, 2002

(51) Int. Cl. G01B 5/00

(52) U.S. Cl. 33/542

(57) ABSTRACT

A measuring instrument for measuring the depth and the diameter of inverts in a man hole which consists of only two parts. A first part is a measuring rod having graduations thereon. A second part is in the form of a receptacle which receives the measuring rod therein and is secured therein. A diagonal testing rod extends from the receptacle and has a horizontal footing thereon. A bubble sight glass is attached to the top of the rectangular sleeve.

### CROSS REFERENCE TO RELATED APPLICATIONS

(none)

### STATEMENT REGARDING FED SPONSORED R & D

(none)

### BACKGROUND OF THE INVENTION

This invention relates to a precision invert measuring tool or more particularly to a measuring tool that is used in inaccessible places such as, for example, the location of pipes in a man hole, called inverts. Such measuring processes are difficult to undertake because no direct line of sight can be obtained because the man hole cover opening is always smaller in diameter than the man hole itself. Therefore, a regular straight ruler or long and extendible yardstick will always line up with a pipe installed at the bottom or near the bottom at an angle which defeats a precise reading of the distance of any pipe deep in the man hole relative to a top of the man hole. It is important that such readings be undertaken when a housing community is being built and the builder needs to know the precise location of underground drainage pipes, whether sewage or storm water drains, to be assured that there is a complete and accurate function of the drainage system.

U.S. Pat. No. 5,309,644 illustrates and describes an instrument for measuring the invert of a sewage pipe relative to a man hole upper surface. This instrument requires quite a few parts to be successfully assembled to accomplish its task. Such an instrument is liable to be misaligned because of so many different parts.

U.S. Pat. No. 4,744,151 shows a surveying instrument which is being attached to a surveying or measuring rod. This is not the inventive concept.

U.S. Pat. No. 4,536,960 relates to a measuring tool and in particular to a caliper. The invention of this patent is arranged primarily for reading inside diameters or distances and outside diameters or distances at inaccessible locations.

U.S. Pat. No. 4,462,166 illustrates a telescoping measuring rafter with locking devices which will measure the pitch of any roof.

U.S. Pat. No. 3,995,373 discloses a measuring device for ascertaining the diameter and depth location of a remotely located pipe including a stationary rod section and a movable rod section slidably carried thereby. This device consists of many parts.

### BRIEF SUMMARY OF THE INVENTION

The inventive instrument requires only two parts to be assembled to thereby be ready for use in the field for which it is designed. There is one long measuring rod and a lower receptacle having a laterally extending test probe attached thereto.

### BRIEF DESCRIPTION OF THE DRAWINGS

FIG. 1 illustrates the use of the inventive instrument in a man hole having inverts therein;

FIG. 2 shows the lower end of the instrument by itself.

### DETAILED DESCRIPTION OF THE INVENTION

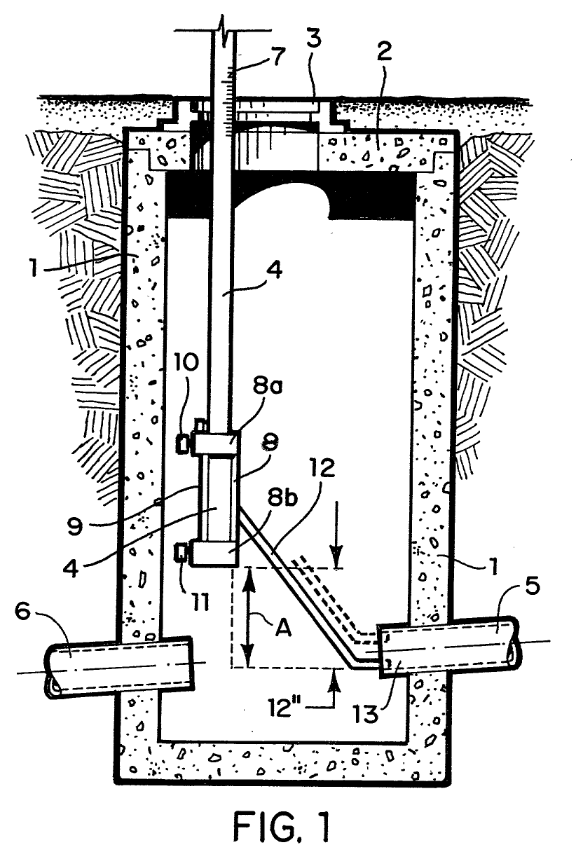

FIG. 1 shows a typical man hole 1 having at its top a concrete cover 2 which is further covered by a cast iron cover 3 which forms the top of the surface of the ground or the road surface. This cast iron cover 3 is normally closed by a round steel plate (not shown). This steel plate and the corresponding cast iron cover 3 is normally considerably smaller than the diameter of the man hole 1 and is offset therefrom as can be seen in FIG. 1. This offset makes it difficult to take precise measurements of the inverts 5 and 6 in the bottom of the man hole. As mentioned above, the measuring instrument of this invention consists of only two parts movable relative to each other. The first part is the measuring rod 4 having visible graduations 7 thereon at the top of the rod by which precise readings can be obtained of the depths of the inverts 5 and 6 and their diameters.

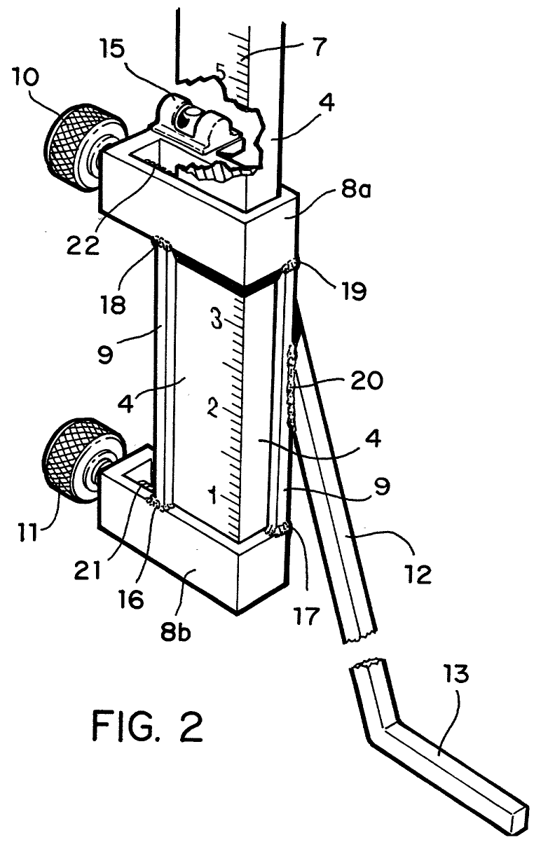

FIG. 2 shows the second part in more detail. The receptacle 8 consists of a lower rectangular box 8b and an upper rectangular sleeve 8a. Both the box 8b and the sleeve 8a are connected to each other by an L-shaped piece of iron 9, by welding 16, 17, 18 and 19, to form a rigid receptacle To assemble the two parts 4 and 8 it is merely necessary to guide the measuring rod into the receptacle 8 through the rectangular sleeve 8a until it hits bottom in the rectangular box 8b. Thereafter the two thumbscrews 10 and 11 are fastened against the measuring rod 4 to thereby securely fasten the measuring rod within the rectangular box 8b and the rectangular sleeve 8a. On the backside of the L-shaped piece of iron there is welded thereto a diagonal test probe 12 having a footing 13 extending therefrom. The diagonal test probe is diagonally extending from the receptacle 8 at exactly 45° and the footing continues to extend from the test probe at ±125°. The distance between the bottom of the rectangular box 8b and the bottom of the footing is exactly 12″ or one foot. On the upper rectangular sleeve there is mounted a bubble sight glass 15 to indicate the horizontal of the rectangular sleeve 8a and, of course, thereby the exact vertical alignment of the measuring rod 4 which is important in obtaining precise readings on the scale or graduations 7 relative to the top of the cast iron cover 3.

In the event that measurements are to be taken of the depth of the inverts 5 and 6 in the man hole 1, it is merely necessary to connect the measuring rod 4 in the receptacle 8 and the instrument can be lowered into the man hole 1. Thereafter, the diagonal testing rod is inserted into any one of the inverts 5 or 6 and the bubble in the sight glass 16 is visually aligned in the center of the glass by maneuvering the measuring rod 4. After that, a precise reading can be taken on the scale 7 relative to the top of the cast iron cover 3.

What I claim is:

1. An invert measuring instrument adapted to be used in measuring precise locations of inverts in the bottom of a man hole, said instrument comprising two parts, a first part consisting of an elongated rod having graduations thereon, a second part forming a receptacle for receiving a bottom of said elongated rod therein, said receptacle including a lower rectangular box and an upper rectangular sleeve and an L-shaped piece of iron rigidly connecting said rectangular box and said rectangular sleeve together, means for securing said measuring rod within said receptacle, a diagonal testing rod rigidly attached to said receptacle, said diagonal rod having a horizontal footing thereon.

2. The invert measuring instrument of claim 1 including a bubble sight glass attached to said rectangular sleeve.

3. The invert measuring instrument of claim 1 wherein said means for securing include a thumbscrew on each of said rectangular box and said rectangular sleeve.
